(19) United States
(12) Patent Application Publication
(10) Pub. No.: US 2016/0129681 A1
(43) Pub. Date: May 12, 2016

(54) METHOD FOR PRODUCING COMPOSITE WORKPIECES

(71) Applicant: Airbus Operations GmbH, Hamburg (DE)

(72) Inventor: Stephan HOETZELDT, Hamburg (DE)

(21) Appl. No.: 14/939,260

(22) Filed: Nov. 12, 2015

(30) Foreign Application Priority Data
Nov. 12, 2014 (DE) 10 2014 116 564.0

(51) Int. Cl. B32B 37/18; B32B 37/06; B32B 37/10; B32B 37/12; B32B 38/10

(52) U.S. Cl. CPC B32B 37/18; B32B 37/12; B32B 38/10; B32B 37/10; B32B 37/06; B32B 2305/72

(57) ABSTRACT

Method for producing a workpiece from a composite material, comprising the steps of: providing an assembly or stack which is formed from a first metal plate, a composite material panel and a second metal plate, deforming the assembly in a machine tool and curing the composite material between the two metal plates outside of the machine tool. The composite material panel can comprise a fibre-reinforced plastics material, for example, and the metal plates can be formed as punched plates.

### CROSS-REFERENCE TO RELATED APPLICATIONS

This application claims priority to German Patent Application No. 10 2014 116 564.0, filed 12 Nov. 2014, which is incorporated herein by reference in its entirety.

### TECHNICAL FIELD

The embodiments herein relate to a method for producing composite workpieces, i.e. to a method for producing workpieces which comprise a composite material such as a fibre-reinforced plastics material. In particular, this embodiment relates to a method for producing 3D moulded parts from a composite material.

### BACKGROUND

Nowadays, three-dimensional moulded parts, i.e. semi-finished products and workpieces, can be produced from composite materials. Hand lamination methods, fibre spraying technology, wet pressing methods, injection methods or prepreg techniques, for example, can be used here as production methods, and they substantially differ from one another to the extent to which fibres are introduced in an automated manner into a plastics material such as a thermoplastic.

On one hand, three-dimensional moulded parts can be directly produced on a three-dimensional tool by applying fibres and plastics material, either alternately or simultaneously, to the tool. On the other hand, three-dimensional moulded parts can be produced from a two-dimensional starting material or semi-finished product, whereby the two-dimensional starting material is drawn, pushed and/or pressed into the desired three-dimensional shape during a shaping step.

Two-dimensional composite materials as the starting material for three-dimensional moulded parts can, if they only have a thickness of a few millimetres, be produced having a length of up to 250 m, it being possible in this case for the two-dimensional composite materials to be rolled onto reels so that a processing process can be conducted.

During additional processing, the two-dimensional composite materials are first cut to have a suitable contour and then manually or automatically fed to a machine tool for deforming, for example a press.

The desired three-dimensional shape is achieved in the machine tool, and once the composite material has cured, the three-dimensional moulded part can be removed from the machine tool.

A production process of this kind is problematic in that the chemical and/or thermal curing of the composite material in the machine tool takes a long time, meaning that the machine tool cannot be used to produce additional moulded parts during this time. This aspect contributes to the costs of producing a three-dimensional moulded part from a composite material. If the desire is to produce a larger number of moulded parts, it may therefore be necessary to provide several entire production lines including the machine tools in order to achieve the desired total number of items in processes running in parallel.

It is an object to provide a method suitable for reducing the costs of producing a composite workpiece.

The core aspect of the embodiment is to make it possible to remove a deformed, but not yet cured workpiece from a shaping machine tool with the aid of an expendable mould in order to be able to reuse the machine tool immediately thereafter to produce an additional workpiece. In other words, an embodiment proposes leaving three-dimensional moulded parts made of composite materials to cure outside a shaping machine tool.

In general, a method for producing a workpiece from a composite material thus comprises the steps of: providing an assembly or stack which is formed from a first metal plate, a composite material panel, and a second metal plate, deforming the assembly in a machine tool and curing the composite material between the two metal plates outside the machine tool. The composite material panel can comprise a fibre-reinforced plastics material for example, it being possible for the fibres to be carbon fibres and/or glass fibres and/or aramid fibres and/or other fibres, and the metal plates can be formed as perforated metal plates or as punched plates.

After the composite material has cured, the two metal plates can be separated from the deformed and cured composite material panel.

The two metal plates form a mould which stabilises the deformed and not yet cured composite material panel until the composite material has cured and which serves no further purpose once it has been separated from the composite material panel, as a result of which the mould formed by two metal plates can be referred to as an expendable mould.

According to one embodiment, in the method, an adhesive film can furthermore be provided in order to bond the composite material panel to one of the metal plates, it being possible for the adhesive film to be perforated. Bonding the composite material panel to one or to both metal plates can be advantageous if the assembly made up of the composite material panel and metal plates are intended to be moved between different processing stations. As a consequence, the adhesive film can be removed again once the composite material has cured. For example, the adhesive film can comprise a material which dissolves in water or in another suitable solvent. If the metal plates are formed as punched plates, the water or solvent can reach the adhesive film easily and quickly through the holes. The dissolution of the adhesive film makes it easier for the metal plates to be separated from the composite material panel.

According to a further embodiment, the assembly can furthermore be packaged in an air-tight manner after deforming in order to facilitate the curing process. As a consequence, the assembly is disassembled again once it has cured. In addition, as a result of evacuating the air-tight package, it can be ensured that degassing occurs, as a result of which fewer air bubbles are present in the composite material. If the sheet metal is punched and the adhesive films are perforated, the desired degassing is facilitated. Degassing can improve the quality of the moulded part produced.

Curing of the composite material is assisted by pressure, temperature, and/or light. Curing can therefore take place in an oven, an autoclave or near lamps, in particular lamps which radiate light having a certain wavelength.

The deformed and cured composite workpiece can be finished by deburring, dyeing and/or marking.

The above-described aspects and further aspects, features and advantages can also be seen in the examples of the embodiments which are described in the following with reference to the accompanying drawings.

### BRIEF DESCRIPTION OF THE DRAWINGS

The various embodiments will hereinafter be described in conjunction with the following drawing figures, wherein like numerals denote like elements, and:

FIG. 1 is a flow diagram which schematically illustrates a method.

FIG. 2 shows an assembly as a two-dimensional starting material.

FIG. 3 shows a deformed assembly.

FIG. 4 shows a composite material panel which is separated from the metal plates once it has cured.

In the figures, the same reference numerals are used for identical or at least similar elements, components or aspects. It is noted that embodiments which are merely illustrative and non-restrictive are described in detail in the following.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

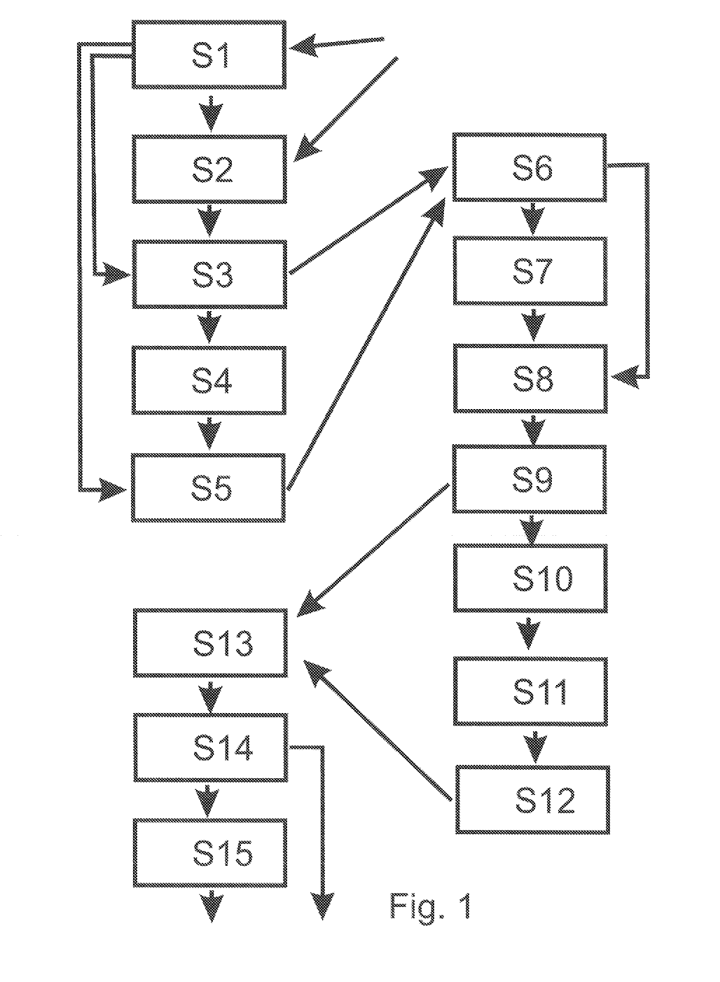

FIG. 1 is a flow diagram which in principle shows the steps of a method for producing a three-dimensional moulded part using an expendable mould. It is noted that the steps described are main steps, wherein said main steps can be differentiated and divided into sub-steps. In addition, additional sub-steps can be provided between the main steps. Therefore, a sub-step is only mentioned when said step is crucial for the understanding of the principle of the method.

Steps S1 to S7 illustrate steps for providing an assembly which comprises at least one composite material panel and two metal plates.

In step S1, a metal plate is placed on a work substrate. In step S2, an adhesive film is either placed separately on a work substrate or placed on the metal plate. In step S3, a composite material panel is placed on the adhesive film. In step S4, an additional adhesive film is placed on the composite material panel.

It is noted that, when carried out separately, steps S2 to S4 provide a composite material panel which is provided with an adhesive film on both its upper and lower side. A composite material panel provided in this way can be prefabricated as a semi-finished product, it being possible for the composite material panel and the adhesive films to be rolled onto a reel as long as the adhesive effect of the adhesive film is low enough for the rolled-up composite material panel not to be prevented from peeling off when it is unrolled.

Thus, either an adhesive film, a composite material panel and an additional adhesive film, or according to S5 a prefabricated combination of adhesive films and a composite material panel, can be applied individually to a metal plate which is deposited on a work substrate in step S1.

It is noted that the assembly can also be formed without adhesive films, i.e. a composite material panel can be placed directly on a first metal plate and a second metal plate can then be placed directly on the composite material panel. In this case, steps S2 and S4 are omitted.

In step S6, a second metal plate is deposited on the uppermost adhesive film or on the composite material panel.

In step S7, the finished assembly can be temporarily stored. The finished assembly is preferably cooled to prevent the composite material from curing prematurely in the assembly. Alternatively, the finished assembly can be directly further processed, i.e. without being temporarily stored.

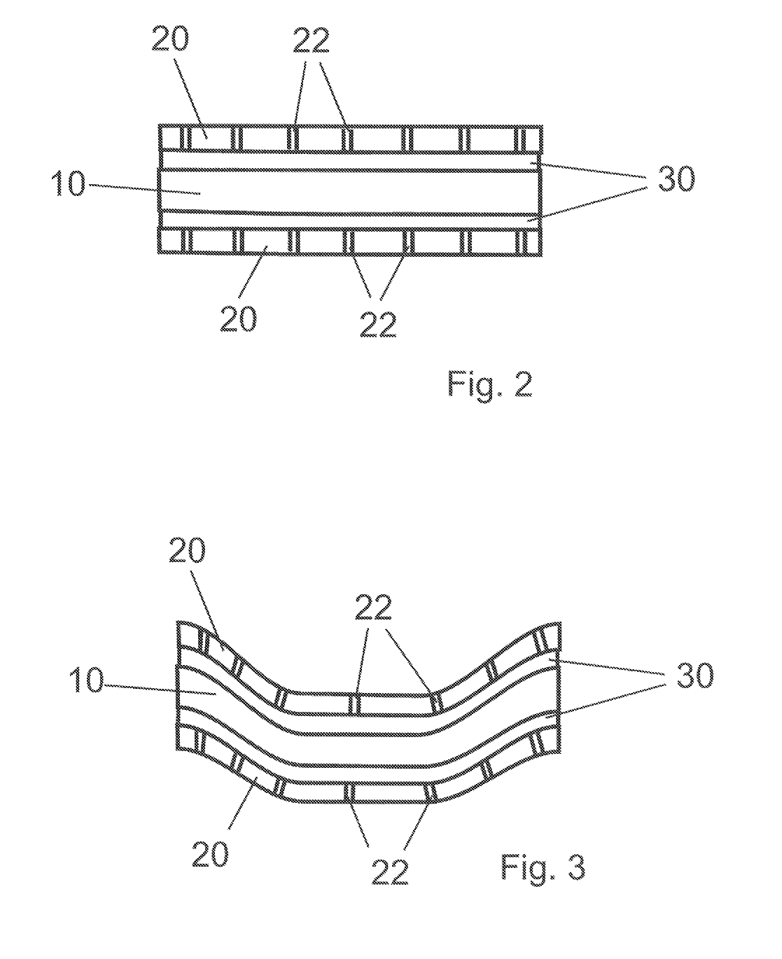

A completed assembly is shown schematically in FIG. 2. The assembly comprises a composite material panel 10 between two adhesive films 30, a metal plate 20 being arranged on either external surface of the adhesive films in each case. Each of the metal plates 20 comprises holes 22 which are equally spaced apart. It is noted that the metal plates 20 can have a thickness of from 0.5 mm to 3 mm and that the composite material panel 10 can have a thickness of from 0.5 mm to 7 mm.

In step S8, the prefabricated two-dimensional assembly is cut. Laser cutting, waterjet cutting or another mechanical separating method can be used for this purpose. It is noted that the metal plates and the composite material panel can also first be cut and only joined together thereafter to form an assembly.

The cut two-dimensional assembly articles are given a desired three-dimensional shape in step S9 and are removed in a manual or automated manner directly thereafter from the machine tool used for this purpose. In particular, the assembly article is removed from the machine tool as long as the composite material in the assembly article is not yet hard or has not yet cured either. A deformed assembly article having a composite material panel 10, adhesive films 30 and metal plates 20 is shown schematically in FIG. 3.

In step S10, the three-dimensionally shaped assembly articles are vacuum-packed in order to be treated in step S11 in an oven, an autoclave or by means of lighting such that the composite material cures inside the assembly. In step S12, the treated assembly is unpacked again. The adhesive films can be perforated in order to facilitate the removal of gases from the composite material by being drawn by a vacuum.

The method can also be carried out without steps S10 and S12. The composite material also cures when the assembly is treated in a manner different to that described in step S11.

The composite material moulded part which has cured in the meantime is separated from the metal plates in step S13, for example by submerging the assembly in water, causing the adhesive films to dissolve. The metal plates can be micro-perforated, making it easier for water or solvent to penetrate and therefore speeding up dissolution of the adhesive film.

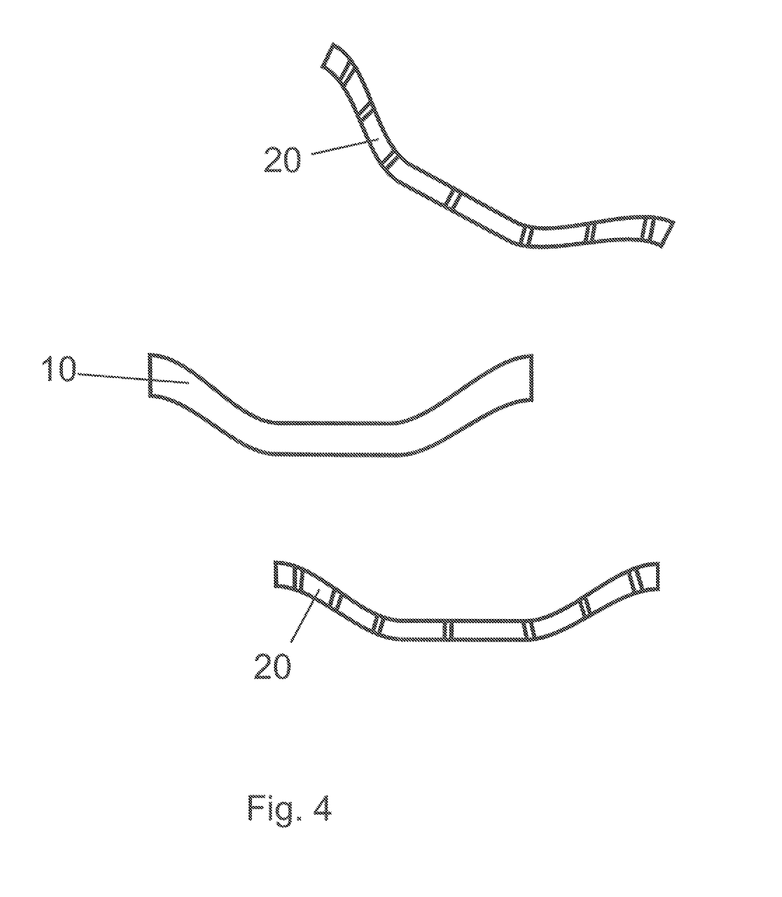

As shown schematically in FIG. 4, the metal plates are removed from the moulded part in step S14, it being possible for the metal plates to be magnetic for this purpose. The cured moulded part is finished in step S15, depending on the requirement and intended use, for example the mould is deburred, dyed, designed by applying colours and/or marked in some other way.

While the embodiment has been illustrated and described in detail in the drawings and the above description, illustrations and descriptions of this type are merely intended to be illustrative or exemplary and are not restrictive, and therefore the embodiments are not limited by the embodiments disclosed. In the claims, the word “comprising” does not exclude other elements and the indefinite article “a” or “an” does not exclude a plurality.

The mere fact that particular features are specified in different dependent claims does not limit their subject matter. Combinations of these features may also be advantageously used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A method for producing a workpiece from a composite material, comprising:
providing a composite material panel, wherein the composite material of the composite material panel is not cured,
providing a first metal plate and a second metal plate,
arranging the first and second metal plates on opposite sides of the composite material panel such that an assembly comprising of the first metal plate, the composite material panel and the second metal plate is formed,
placing the assembly in a machine tool,
deforming the assembly in the machine tool,
removing the deformed assembly from the machine tool,
curing the composite material, and
separating the metal plates from the deformed and cured composite material panel.

2. The method according to claim 1, further comprising the steps of:
providing an adhesive film between the composite material panel and the first metal plate and/or the second metal plate, and
removing the adhesive film after the composite material has cured.

3. The method according to claim 2, wherein removing the adhesive film comprises dissolving the adhesive film, and wherein the adhesive film is removed before the metal plates are separated from the deformed composite material panel.

4. The method according to claim 1, further comprising:
packaging the assembly when the assembly has deformed,
sealing the packaged assembly prior to curing, and
unpacking the assembly after curing.

5. The method according to claim 4, wherein the method further comprises evacuation after sealing.

6. The method according to claim 1, wherein curing the composite material involves the composite material being treated by means of at least one of pressure, temperature and light.

7. The method according to claim 1, further comprising cutting the assembly before the assembly is deformed.

8. The method according to claim 1, further comprising finishing the composite workpiece, wherein finishing the composite workpiece involves at least one of deburring, dyeing and marking.

9. The method according to claim 1, wherein the composite material is a fibre-reinforced plastics material.

10. The method according to claim 1, wherein the metal plates are formed as punched metal sheets.

11. A method for producing a workpiece from a composite material, comprising:
providing a composite material panel, wherein the composite material of the composite material panel is not cured,
providing a first metal plate and a second metal plate,
arranging the first and second metal plates on opposite sides of the composite material panel such that an assembly comprising of the first metal plate, the composite material panel and the second metal plate is formed,
placing the assembly in a machine tool,
deforming the assembly in the machine tool,
removing the deformed assembly from the machine tool,
curing the composite material, and
separating the metal plates from the deformed and cured composite material panel, and
providing an adhesive film between the composite material panel and the first metal plate and/or the second metal plate, and
removing the adhesive film after the composite material has cured,
wherein removing the adhesive film comprises dissolving the adhesive film, and wherein the adhesive film is removed before the metal plates are separated from the deformed composite material panel.

12. The method according to claim 11, further comprising:
packaging the assembly when the assembly has deformed,
sealing the packaged assembly prior to curing,
unpacking the assembly after curing, and
evactuition after sealing.

13. The method according to claim 11, wherein curing the composite material involves the composite material being treated by means of at least one of pressure, temperature and light.

14. The method according to claim 1, further comprising:
cutting the assembly before the assembly is deformed, and
wherein the metal plates are formed as punched metal sheets.

15. The method according to claim 11, wherein the composite material is a fibre-reinforced plastics material, and the metal plates are formed as punched metal sheets.
